(19) United States
(12) Patent Application Publication
(10) Pub. No.: US 2016/0286270 A1
(43) Pub. Date: Sep. 29, 2016

(54) KIND OF INTERACTIVE SHARING PLATFORM INTEGRATING TV BROADCASTING AND MOBILE COMMUNICATION

(71) Applicant: ECRENT WORLDWIDE COMPANY LIMITED, Hong Kong (CN)

(72) Inventor: Wai Ming Deborah YUEN, Hong Kong (CN)

(73) Assignee: ECRENT WORLDWIDE COMPANY LIMITED, Hong Kong (CN)

(21) Appl. No.: 14/705,101

(22) Filed: May 6, 2015

(30) Foreign Application Priority Data
Mar. 25, 2015 (CN) 20150132278.9

(51) Int. Cl. H04N 21/462; H04N 21/63; H04N 21/2665; H04N 21/4782; H04N 21/414; H04N 21/61

(52) U.S. Cl. CPC H04N 21/4622; H04N 21/41407; H04N 21/6131; H04N 21/2665; H04N 21/4782; H04N 21/6125; H04N 21/6175; H04N 21/6181; H04N 21/632

(57) ABSTRACT

An interactive sharing platform integrating TV broadcasting and mobile communication, which synchronously pushes the pre-determined interactive contents through the intelligent control service system to the mobile communication equipment in the form of internet according to different TV broadcasting contents and displays the same to the audience in the form of application; the audience will give interactive feedback to the intelligent control service system by taking application as the interactive interface. The results of statistical analysis on such interactive feedback will be shared in such a way as to make the most of the data. Based on integrating TV broadcasting and mobile communication, this invention realizes two-way interaction between TV broadcasting and the audience, and improves the degree of participation of the audience and the attractiveness of TV broadcasting, and thus gives full play to the advantages of TV broadcasting, internet and mobile communication.

### FIELD OF THE INVENTION

This invention is related to a kind of data communication and sharing technology, which specifically is about a kind of information interaction and sharing platform integrating TV broadcasting and mobile communication.

### BACKGROUND OF THE INVENTION

At present, with the rapid development of the internet and smart mobile communication devices, the mobile communication has gradually substituted the traditional TV broadcasting in the market, especially the youth market due to such characteristics as two-way interaction and high user involvement. However, TV broadcasting enjoys a good user base, which represents powerful and stable communication strength, due to its long development history and sophisticated hardware facilities. Therefore, compared with competing between TV broadcasting and the rapid-developing mobile communication transmission, combining the two to form a two-way interaction and information sharing platform and build a transmission network featuring larger scope, wider audience, higher degree of participation and stronger attractiveness will be a more promising development orientation.

### SUMMARY OF THE INVENTION

In light of the shortcomings of the existing technology, this invention is aimed at providing an interactive sharing platform integrating TV broadcasting and mobile communication, and transforming TV broadcasting from one-way content pushing to two-way interaction between TV broadcasting and the audience through combination of the internet, mobile communication equipment and TV broadcasting, in order to build an interactive sharing platform integrating content pushing, TV broadcasting-audience two-way interaction, and information sharing.

To this end, this invention employs the following technological plan:

A kind of interactive sharing platform integrating TV broadcasting and mobile communication equipment, which includes the intelligent control service system that is mainly composed of receiver module, transmitting module, storage module, control module and timing module, of which the receiver module is connected with the storage module, timing module and transmitting module is connected to the control module respectively, and the storage module is connected to the control module; in addition, the above-mentioned interactive sharing platform also includes broadcast control terminal, covering server, video server, broadcast server, TV and radio transmitting antenna, TV terminal, and mobile communication equipment.

Intelligent control service system, connected to the broadcast control terminal and mobile communication equipment respectively through internet, is mainly used for receiving program and interactive contents from the broadcast control terminal and sending the same to the video server for storage. Such program and interactive contents will be indexed as per the play time; besides, it is also responsible for sending corresponding interactive interface to the mobile communication equipment according to the play time;

Covering server, with signal connection with the video server and intelligent control service system respectively, is mainly used to cover the contents originating from the intelligent control service system that need to be displayed in the form of coverage into corresponding video content and store the same in the video server. Such contents will be sent via broadcast server and TV and radio transmitting antenna to the TV terminal for broadcasting;

Video server, connected to the covering server and broadcast server respectively, is mainly used to store the program contents indexed according to the play time;

Broadcast server is mainly used to select corresponding program contents from the video server according to the pre-set time, and send the same via TV and radio transmitting antenna to the TV terminal for broadcasting;

Mobile communication equipment is mainly used for receiving the interactive interface originating from the intelligent control service system and synchronically updated along with TV terminal program contents, and receiving the same to the audience in the form of application.

It should be noted that the intelligent control service system is the core of the entire interactive sharing platform. It synchronizes the interactive interface displayed by the mobile communication equipment in the form of application with TV broadcasting programs in terms of broadcasting time, i.e. when a TV terminal broadcasts a specific program at a certain time, the mobile communication equipment application could be updated to an interactive interface related to such program, and the audience could respond to the interactive contents showed in the program via the above interactive interface. This transforms TV broadcasting from one-way content pushing to two-way interaction between TV broadcasting and the audience, which increases the degree of participation of the audience, and enhances the attractiveness of TV broadcasting to the audience, especially to young people.

It should be noted that the aforesaid interactive sharing platform also has a data storage and analysis system which is only and directly connected to the intelligent control service system; the aforesaid data storage and analysis system includes data sending-receiving unit, storage unit and statistical analysis unit; the aforesaid data sending-receiving unit is mainly used to do bi-directional data transmission with the intelligent control service system; the statistical analysis unit is used to do statistical analysis on the interactive feedback data originating from the intelligent control service system. The statistical analysis result is stored in the storage unit and sent back to the intelligent control service system via data sending-receiving unit.

It should be further noted that the data storage and analysis system allows for real-time statistical analysis of the interactive feedback data sent back by the audience through the mobile communication equipment, which provides favorable conditions for the real-time or after-event sharing and application of the statistical analysis result. In addition, the aforesaid data storage and analysis is only and directly connected to the intelligent control service system, which can ensure uniform and standardized data management.

It should be further noted that the intelligent control service system is also directly connected to the broadcast server, and can send to the broadcast server a command, designating specific program content from the video server for sending to the TV broadcast transmitting antenna. This allows the audience to join in the decision-making in respect of TV broadcasting program contents by means of interaction, and thus further increases the sense of participation of the audience, enhances the attractiveness of TV broadcasting, also is conducive to the collection of information about the audience's preference.

It should be noted that the aforesaid interactive sharing platform also includes the camera equipped with data sending unit, which will send the video content shot in real time to the digital circuit decoder via the data transmission unit, and the digital circuit decoder will send the decoded video content to the video server. The route setting of the camera with data sending unit, digital circuit decoder, video server, broadcast server, TV and radio transmitting antenna, and TV terminal enables the program content recorded and broadcasted in real time to interact with the audience through the intelligent control service system in addition to the prerecorded program content so long as the broadcasting time and interactive content is determined in advance.

It should be noted that the aforesaid interactive sharing platform includes numerous intelligent control service systems which are distributed in multiple locations. The connection of each intelligent control service system to the mobile communication equipment and the broadcast control terminal is under uniform management by the wisdom router which is connected to the broadcast control terminal and mobile communication equipment via the internet. Setting many intelligent control service systems and distributing them at different locations, and keeping them under uniform management and scheduling by the wisdom router could build the intelligent control service system into a structure featuring multi-site distribution, balanced load and failover, so as to provide synchronically interactive TV broadcasting programs for millions of audience 24 hours a day and 365 days a year.

It should be noted that each intelligent control service system corresponds to a data storage and analysis system, and each data storage and analysis system and its corresponding intelligent control service system are located at the same site; in addition, all data storage and analysis systems on the interactive sharing platform can synchronize data via the internet. Such a setting can ensure the efficiency of data access and the security of data transmission and storage between the intelligent control service system and the data storage and analysis system.

It should be further noted that the same covering server or broadcast server can only be connected with one intelligent control service system.

It should be noted that the intelligent control service system also has an access control interface which can be used to certify the access authority of a thirty-party system. With such authority, the thirty-party system will not be allowed to connect with the intelligent control service system and request sharing the data permitted to be acquired within the authority, which is conducive to identifying the data user's identity so as to ensure reasonableness and security of data use. Such authority can be given with a charge or for free.

It should be noted that the supported mobile communication equipment includes but not limited to smart phones and tablet computers.

It should be noted that the operating system of mobile communication equipment may include but not limited to Android system, IOS system, BlackBerry system, or Windows system.

This invention is equipped with the following beneficial effects:

1. To combine TV broadcasting and mobile communication via the intelligent control service system, maintain synchronous updating of the TV broadcasting program contents and the interactive interface shown by the mobile communication equipment application, and thus realize the real-time interaction between TV broadcasting and the audience;

2. The data storage and analysis system is only and directly connected to the intelligent control service system, which ensures the uniform and standardized data sending and receiving, analysis and storage as well as the security of data;

3. Setting many intelligent control service systems and building them into a structure featuring multi-site distribution, balanced load and failover, so as to provide synchronically interactive TV broadcasting programs for millions of audience 24 hours a day and 365 days a year;

4. Date sharing is limited by authority and uniform access certification is done by the intelligent control service system, which is conducive to identifying the data user's identity so as to ensure reasonableness and security of data use;

5. The data storage and analysis system and the intelligent control service system correspond to each other and are distributed at the site, which effectively ensures the efficiency of data access and the security of data transmission.

### BRIEF DESCRIPTION OF THE DRAWINGS

FIG. 1 is a block diagram of overall connection of this invention.

FIG. 2 is a block diagram of the connecting relations among all parts when several intelligent control service systems are used.

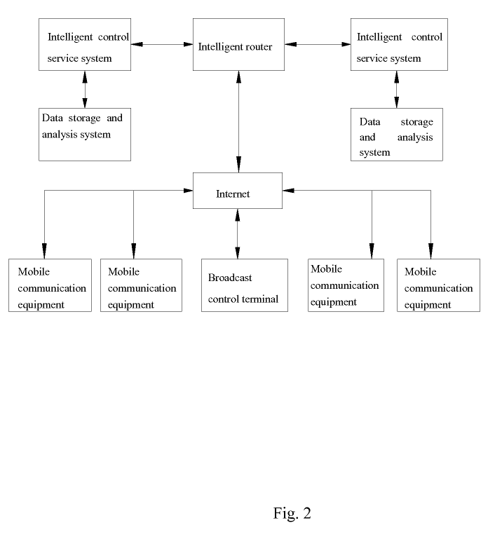

### SPECIFIC EMBODIMENT METHOD

Further description of this invention is given below in combination with the figures. It should be noted that this embodiment example is premised on this technological plan and puts forward the detailed embodiment method and specific operating procedures. However, the protection scope of this invention is not limited to this embodiment example.

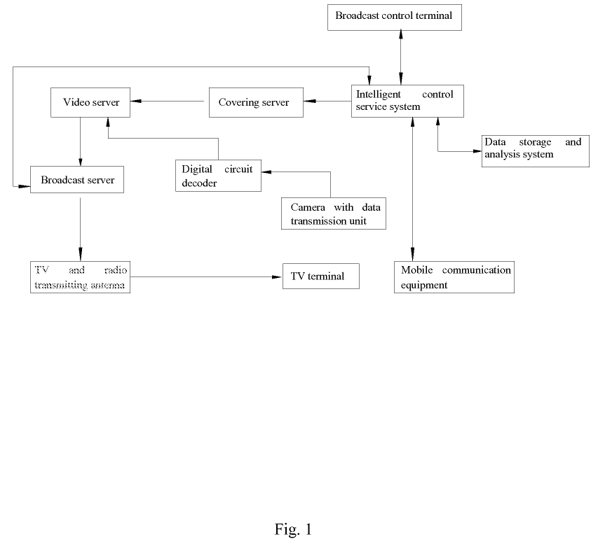

A kind of interactive sharing platform integrating TV broadcasting and mobile communication equipment as shown in FIG. 1, which includes the intelligent control service system that is mainly composed of receiver module, transmitting module, storage module, control module and timing module, of which the receiver module is connected with the storage module, timing module and transmitting module is connected to the control module respectively, and the storage module is connected to the control module; in addition, the above-mentioned interactive sharing platform also includes broadcast control terminal, covering server, video server, broadcast server, TV and radio transmitting antenna, TV terminal, and mobile communication equipment;

Intelligent control service system, connected to the broadcast control terminal and mobile communication equipment respectively by interne, is mainly used for receiving program and interactive contents from the broadcast control terminal and sending the same to the video server for storage. Such program and interactive contents will be indexed as per the play time; besides, it is also responsible for sending corresponding interactive interface to the mobile communication equipment according to the play time;

Covering server, with signal connection with the video server and intelligent control service system respectively, is mainly used to cover the contents originating from the intelligent control service system that needs to be displayed in the form of coverage into corresponding video content and store the same in the video server. Such contents will be sent via broadcast server and TV and radio transmitting antenna to the TV terminal for broadcasting;

Video server, connected to the covering server and broadcast server respectively, is mainly used to store the program contents indexed according to the play time;

Broadcast server is mainly used to select corresponding program contents from the video server according to the pre-set time, and to send the same via TV and radio transmitting antenna to the TV terminal for broadcasting;

Mobile communication equipment is mainly used to receive the interactive interface originating from the intelligent control service system and synchronically updated along with TV terminal program contents, and to display the same to the audience in the form of application.

It should be noted that the intelligent control service system is the core of the entire interactive sharing platform. It synchronizes the interactive interface displayed by the mobile communication equipment in the form of application with TV broadcasting programs in terms of broadcasting time, i.e. when a TV terminal broadcasts a specific program at a certain time, the mobile communication equipment application could be updated into an interactive interface related to such program, and the audience could respond to the interactive contents showed in the program via the above interactive interface. This transforms TV broadcasting from one-way content pushing to two-way interaction between TV broadcasting and the audience, which increases the degree of participation of the audience, and enhances the attractiveness of TV broadcasting to the audience, especially to young people.

It should be noted that the aforesaid interactive sharing platform also is equipped with a data storage and analysis system which is only and directly connected to the intelligent control service system; the aforesaid data storage and analysis system includes data sending-receiving unit, storage unit and statistical analysis unit; the aforesaid data sending-receiving unit is mainly used to do bi-directional data transmission with the intelligent control service system; the statistical analysis unit is used to make statistical analysis of the interactive feedback data originating from the intelligent control service system. The statistical analysis result is stored in the storage unit and sent back to the intelligent control service system via data sending-receiving unit.

It should be further noted that the data storage and analysis system allows for real-time statistical analysis of the interactive feedback data sent back by the audience through the mobile communication equipment, which provides favorable conditions for the real-time or after-event sharing and application of the statistical analysis result. In addition, the aforesaid data storage and analysis is only and directly connected to the intelligent control service system, which can ensure uniform and standardized data management.

It should be further noted that the intelligent control service system is also directly connected to the broadcast server, and can send to the broadcast server a command, designating specific program content from the video server for sending to the TV broadcast transmitting antenna. This allows the audience to join in the decision-making in respect of TV broadcasting program contents by means of interaction, and thus further increases the sense of participation of the audience, enhances the attractiveness of TV broadcasting, also is conducive to the collection of information about the audience's preference.

It should be noted that the aforesaid interactive sharing platform also includes the camera equipped with data sending unit, which will send the video content shot in real time to the digital circuit decoder through the data transmission unit, and the digital circuit decoder will send the decoded video content to the video server. The route setting of the camera with data sending unit, digital circuit decoder, video server, broadcast server, TV and radio transmitting antenna, and TV terminal allows the program content recorded and broadcasted in real time to interact with the audience through the intelligent control service system in addition to the prerecorded program content so long as the broadcasting time and interactive content is determined in advance.

It should be noted that the aforesaid interactive sharing platform includes numerous intelligent control service systems which are distributed in multiple locations. The connection of each intelligent control service system to the mobile communication equipment and the broadcast control terminal is under uniform management by the wisdom router which is connected to the broadcast control terminal and mobile communication equipment through the internet. Setting many intelligent control service systems and distributing them at different locations, and keeping them under uniform management and scheduling by the wisdom router could build the intelligent control service system into a structure featuring multi-site distribution, balanced load and failover, so as to provide synchronically interactive TV broadcasting programs for millions of audience 24 hours a day and 365 days a year.

It should be noted that each intelligent control service system corresponds to a data storage and analysis system, and each data storage and analysis system and its corresponding intelligent control service system are located at the same site; in addition, all data storage and analysis systems on the interactive sharing platform can synchronize data via the internet. Such a setting can ensure the efficiency of data access and the security of data transmission and storage between the intelligent control service system and the data storage as well as analysis system.

It should be further noted that the same covering server or broadcast server can only be connected with one intelligent control service system.

It should be noted that the intelligent control service system also has an access control interface which can be used to certify the access authority of a thirty-party system. With such authority, the thirty-party system will not be allowed to connect with the intelligent control service system and to request sharing the data permitted to be acquired within the authority, which is conducive to identifying the data user's identity so as to ensure reasonableness and security of data use. Such authority can be given with a charge or for free.

It should be noted that the supported mobile communication equipment includes but not limited to smart phones and tablet computers.

It should be noted that the operating system of mobile communication equipment may include but not limited to Android system, IOS system, BlackBerry system, or Windows system.

The process by which the TV and radio synchronize and interact with the audience through the interactive sharing platform described herein is described as follows:

First, the radio control terminal sends the program content and interactive content to the intelligent control system indexed by time through the interne. The intelligent control system sends the program content and interactive content to the video server for storage. If there are contents that need to be broadcasted or displayed in a covered form, such as text content or chart content, the covering server will cover these contents on the corresponding video content.

Second, in addition to the program content recorded in advance, the program content recorded by the camera with a data-sending unit in real time can be sent to the video server after being decoded by the digital circuit decoder.

Third, the radio server receives the corresponding program content from the video server in accordance with the set time and sends it through the TV and radio transmitting antenna to the TV terminal to be played. When it is time to interact with the audience in real time, the timing module of the intelligent control system described herein sends a signal to the control module. The control module drives the sending module to send the corresponding interactive interface to the mobile communication equipment through the internet and display it on the mobile communication equipment through application to realize the synchronous update of the interactive interface of the mobile communication equipment application and TV and radio programs.

Finally, the audience can interact and give feedback through the interactive interface. The interactive and feedback data are sent to the intelligent control system through the internet; the aforesaid intelligent control system sends the interactive and feedback data to the data storage and analysis system for statistical analysis. The results obtained are stored in the storage unit of the data storage and analysis system and send back to the aforesaid intelligent control system.

It should be noted that if the audience are asked to vote to decide on the next program in the interaction, the intelligent control system can send the instruction to the radio server according to the statistical analysis results to drive it to retrieve corresponding program content from the video server described herein and send it through the TV and radio transmitting antenna to the TV terminal for broadcasting.

It should be further noted that the third-party system, such as enterprises, program production units, etc., can obtain the authority by paying or for free and pass the certification of access control interface to check the statistical analysis materials permitted within the authority, and make use of these data to optimize enterprise management and strategies and improve the program production and content selection and so on.

Technicians in this field can make corresponding changes or variations according to the above-mentioned technological plan as well as ideas. All these changes and variations should fall in the protection scope of the claim of this invention.

What is claimed:

1. A kind of interactive sharing platform integrating TV broadcasting and mobile communication equipment, which is equipped with the features comprising intelligent control service system composed of a receiver module, a transmitting module, storage module, a control module and a timing module, of which the receiver module is connected with the storage module, timing module and transmitting module is connected to the control module respectively, and the storage module is connected to the control module; a broadcast control terminal, a covering server, a video server, a broadcast server, a TV and radio transmitting antenna, a TV terminal, and a mobile communication equipment; wherein
the intelligent control service system, connected to the broadcast control terminal and mobile communication equipment respectively through internet, is used for receiving program and interactive contents from the broadcast control terminal and sending the same to the video server for storage; the program and interactive contents will be indexed as per the broadcasting time, and be responsible for sending corresponding interactive interface to the mobile communication equipment according to the broadcasting time.
a covering server, with signal connection with the video server and intelligent control service system respectively, is used to cover the contents originating from the intelligent control service system that need to be displayed in the form of coverage into corresponding video content and store the same in the video server; the contents will be sent via broadcast server and TV and radio transmitting antenna to the TV terminal for broadcasting;
a video server, connected to the covering server and broadcast server respectively, is used to store the program contents indexed according to the broadcasting time;
a broadcast server is used to select corresponding program contents from the video server according to the pre-set time, and to send the same via TV and radio transmitting antenna to the TV terminal for broadcasting;
a mobile communication equipment is mainly used to receive the interactive interface originating from the intelligent control service system and synchronically updated along with TV terminal program contents, and display the same to the audience in the form of application.

2. The interactive sharing platform integrating TV broadcasting and mobile communication of claim 1, wherein the interactive sharing platform also has a data storage and analysis system which is only and directly connected to the intelligent control service system; the aforesaid data storage and analysis system includes data sending-receiving unit, storage unit and statistical analysis unit; the aforesaid data sending-receiving unit is mainly used to do bi-directional data transmission with the intelligent control service system; the statistical analysis unit is used to make statistical analysis of the interactive feedback data originating from the intelligent control service system, and the statistical analysis result is stored in the storage unit and sent back to the intelligent control service system via data sending-receiving unit.

3. The interactive sharing platform integrating TV broadcasting and mobile communication of claim 1, wherein intelligent control service system is also directly connected to broadcast server, can send to the broadcast server a command, designating specific program content from the video server for sending to the TV broadcast transmitting antenna.

4. The interactive sharing platform integrating TV broadcasting and mobile communication of claim 1, wherein it also includes a camera equipped with a data sending unit, which will send the video content shot in real time to the digital circuit decoder through the data transmission unit, and the digital circuit decoder will send the decoded video content to the video server.

5. The interactive sharing platform integrating TV broadcast and mobile communication of claim 1, wherein it includes a plurality of intelligent control service systems which are distributed in multiple locations, the connection of each intelligent control service system to the mobile communication equipment and the broadcast control terminal is under uniform management by a wisdom router which is connected to the broadcast control terminal and mobile communication equipment via the internet.

6. The interactive sharing platform integrating TV broadcast and mobile communication of claim 5, wherein each intelligent control service system corresponds to a data storage and analysis system, and each data storage and analysis system and its corresponding intelligent control service system are located at the same site; wherein, all data storage and analysis systems on the interactive sharing platform can synchronize data via the internet.

7. The interactive sharing platform integrating TV broadcast and mobile communication of claim 5, wherein the same covering server or broadcast server can only be connected with one intelligent control service system.

8. The interactive sharing platform integrating TV broadcast and mobile communication of claim 1, wherein the intelligent control service system also has an access control interface which can be used to certify the access authority of a thirty-party system.

9. The interactive sharing platform integrating TV broadcast and mobile communication of claim 1, wherein the supported mobile communication equipment includes at least one of smart phones and tablet computers.

10. The interactive sharing platform integrating TV broadcast and mobile communication of claim 9, wherein the operating system of mobile communication equipment includes at least one of Android system, IOS system, BlackBerry system, or Windows system.
